(19) United States
(12) Patent Application Publication
(10) Pub. No.: US 2022/0133053 A1
(43) Pub. Date: May 5, 2022

(54) DEVICES AND METHODS FOR VARYING PRESSURE POINTS OVER TIME IN A SUPPORT DEVICE

(71) Applicant: Zach M. Krachinski, Michigan City, IN (US)

(72) Inventor: Zach M. Krachinski, Michigan City, IN (US)

(21) Appl. No.: 17/517,469

(22) Filed: Nov. 2, 2021

Related U.S. Application Data
(60) Provisional application No. 63/108,637, filed on Nov. 2, 2020.

(51) Int. Cl. A47C 27/08; A47C 31/00

(52) U.S. Cl. CPC A47C 27/083; A47C 31/008; A47C 27/082

(57) ABSTRACT

A variable pressure device includes: a user support device including a plurality of inflatable sub-divisions; a pump or compressor; and a manifold assembly including a plurality of valves controlling output of the pump or compressor to selectively inflate and deflate each of the plurality of inflatable sub-divisions.

### CROSS-REFERENCE TO RELATED APPLICATIONS

This application claims the benefit of priority to U.S. Provisional Application 63/108,637 filed Nov. 2, 2020, the entirety of which is incorporated herein by reference.

### BACKGROUND OF THE INVENTION

The present subject matter relates generally to devices and methods that help mitigate the adverse consequences resulting from long periods spent sitting or lying in a given position on a support (e.g., chair, mattress, etc.). More specifically, the present invention relates to a device secured to, incorporated into, or otherwise associated with a user support structure such as a bed, a chair, or other furniture, the device altering the manner in which weight is distributed through and supported by the support structure so as to vary the location and magnitude of pressure points experienced by the user over time when supported by the support structure.

While most users utilize their beds as a reprieve and haven from the normal daily grind, many other people are confined to bedrest for long periods of time due to old age or sickness. Such confinement may result in general discomfort, pressure sores or ulcers, and blood clots, among other issues. Infants and small babies also spend a significant amount of time sleeping and/or laying in a crib or on a mattress, which can lead to a flat surface forming on the head. These health issues arise from remaining in one position in a bed and/or putting constant pressure on areas of the skin that touch the bed. If pressure is applied in the same area for too long, blood supply can be cut off to certain areas within the body, leading to the breakdown of tissue and muscle.

In order to avoid such health problems, people on bedrest are encouraged to move as much as possible in bed. Patients under the supervision and care of nurses are often repositioned periodically to ensure blood flow to all areas within the body. Such repositioning may occur as frequently as every two hours. Complications can arise with obese patients or patients with cords and tubes attached to ventilators, IV bags, or other medical equipment. Further, pressure ulcers on patients in hospitals may be traced back to insufficient repositioning, raising issues for hospital liability.

Similarly, babies can develop a flat surface on their head where the head contacts a mattress in a crib, a bassinet, a bouncy seat, or other seats for restraint. Babies spend a significant amount of time sleeping and otherwise being restrained, and as their skulls are developing and solidifying over the first year to eighteen months of their lives, the extended periods of time spent laying down or resting their heads can lead to a flattened surface on the backside of the head.

Solutions for reducing the flattened surface on a baby's head include wearing a helmet throughout the day and/or at night. Helmets are often awkward for small babies to manage, particularly given the baby's weak neck muscles and lack of head control.

These are merely two examples of situations in which the user of a bed, chair, or similar support structure would benefit from reducing the impact of static pressure points within the structure. Certainly, there are many more examples, including use of supports like office and school chairs, car seats, etc.

Accordingly, there is a need for devices and methods that enable a support device to alter its support structure to vary the location and magnitude of pressure points experienced by the user over time.

### BRIEF SUMMARY OF THE INVENTION

To meet the needs described above and others, the present invention provides devices and methods for varying the pressure points experienced by a user that is being supported by a support structure to minimize the impact on the user of remaining in a static position on the support structure for long periods of time. Typically speaking, when a user rests on or against a support structure such as furniture, the user's weight or applied force is resisted by the support structure in a manner that creates one or more pressure points against the user's body. If the user remains in position for an extended period of time, the one or more pressure points can cause various adverse health effects, such as general discomfort, pressure sores or ulcers, and blood clots, etc. Accordingly, the furniture described herein cooperates with a variable pressure device that acts to vary the location and magnitude of the pressure points over time.

For example, in one embodiment, the variable pressure device includes a dynamic support member that provides resistance against the user's body during use. The variable pressure devices described herein may be secured to the underside or back side of a support structure such as a mattress, a chair seat, a chair back, an arm rest, a headrest, a footrest, etc. to vary the pressure points experienced by the user. Alternatively the variable pressure device may be incorporated into any cushioned or not cushioned support device, including seats, conventional beds, hospital beds, conventional mattresses, infant mattresses, pillows, foot rests, etc.

In one example, the dynamic support member alters pressure or resistance experienced by the user over a surface area that includes a high pressure portion and one or more low pressure portions. The high pressure portion provides a greater resistance to the user's body than the lower pressure portion(s). The location of the support member shifts over time so that the pressure points experienced by the user similarly shift over time. Movement of the support member can cause a shift in the locations of one or both of the high pressure portion and the low pressure portion(s), the intensity, and/or the magnitude of the pressure experienced by the user. In a first example embodiment, the variable pressure device includes a plurality of subdivisions that are selectively inflated and deflated over time. For example, the variable pressure device may be a mattress body including a series of inflatable subdivisions along a width thereof that are inflated independently of one another. Each subdivision includes a valve that controls the airflow into the respective subdivision, and the valve controls a pressure of the air in the subdivision such that each subdivision (i.e., chamber) may be more or less firm and more or less likely to create a pressure point for a user supported by the device.

More specifically, the mattress body includes dividers that define the subdivisions, with each subdivision spanning first and second end surfaces extending along a length of the mattress body. The first end surface is provided within the mattress body as described in greater detail below. The second end surface forms a right outer side edge of the mattress body. Each subdivision has a curved upper surface extending between adjacent dividers that form a semi-circular shape in cross section.

A manifold is provided along the length of the first end surface of the mattress body, forming a left outer side edge of the mattress body. A valve is provided in the first end surface at each subdivision to regulate airflow into and out of the respective subdivision. The manifold therefore fluidly connects the plurality of subdivisions through the valves. An air compressor provides air to the manifold through tubing.

During use, a user lays along the length of the variable pressure device. Using the air compressor, the air pressure in each subdivision (or sub-grouping of subdivisions) may be increased or decreased over time to vary the location of the pressure applied to different areas of the user's body.

In one example, the mattress body includes 12 parallel subdivisions along the length thereof. The valves of five adjacent subdivisions near a first edge of the mattress body are opened to provide airflow to inflate and deflate various subdivisions, thereby defining a surface area of pressure to the user. In this example, the air pressure in the central subdivision, subdivision 3 of 5, is greatest and is the high pressure portion of the surface area. The subdivisions on each side of the central subdivision, subdivisions 1, 2, 4, and 5, have lower pressure than the central subdivision and are therefore low pressure portions of the surface area.

The high pressure portion of the support surface may slowly shift positions along the length of the mattress body by selectively inflating and deflating various subdivisions. As the high pressure subdivisions move downward, the air pressure in subdivision 4 of 5 increases to the highest air pressure, making subdivision 4 the high pressure portion of the surface area. Similarly, the area of the pressure points experienced by the user may be varied by choosing to inflate a greater or lesser number of subdivisions at any given time. For example, while described above with respect to inflating a single high pressure subdivision at a time, alternative embodiments may inflate a greater number of subdivisions at any point in time. For example, in the five subdivision embodiment described, adjacent or alternating subdivisions may be inflated to a higher pressure or deflated to a lower pressure to alter the pressure points experienced by the user. The adjustment of the air pressure in each subdivision may be controlled as desired or needed automatically according to a timed schedule or manually directed by the user or caretaker.

In other embodiments, the series of subdivisions may include other shapes and structures, such as square or circular air cells or pockets.

The variable pressure device may further include a controller (i.e., computer processor, memory, and related computing elements) to control the operation of the air compressor and the valves. The controller may be controlled by a user interface integral with the variable pressure device or may be remotely controlled, for example, by a mobile or web application.

In a second embodiment, the variable pressure device includes a frame housing, a track, and one or more support members that move along the track. The variable pressure device is secured to the underside of a support structure such as a mattress, a chair, etc., and the support members vary the location and intensity of pressure experienced by the user's body when the user is sitting or lying on the support structure.

Movement of the support members along the track varies the location of pressure applied to the user's body.

The track may have a linear shape, a serpentine shape, a spiral shape, or a series of various shapes. The support members may be a rounded or curved structure, such as a ball or elongated cylinder. In some examples, the support members rotate about the track as they travel along the length thereof and each may have an irregular or asymmetrical shape such that rotation about the track causes varying pressure on the user.

The travel of the support members along the track may be controlled by a motorized drive mechanism, including controls for varying the speed of travel of the support members along the track. It may include a timer such that the support members may travel the track during certain periods of time and not others.

For example, the support members may include one or more primary support members and one or more secondary support members that collectively vary the pressure points experienced by the user. The primary support members are the largest and provide higher pressure portions of the surface area to the user's body while the secondary support members are smaller than the primary support member and therefore provide lower pressure portions of the surface area to the user's body.

In one embodiment, the support members include first and second primary support members with two secondary support members positioned between the first and second primary support members. Each support member has a rounded shape and a bore through which the track extends. In some embodiments, an inner surface of the bore includes a friction surface, or the support member has an associated locking member, so that the respective support member is movable along the track upon the application of sufficient force and remains in its intended position throughout that movement. In other words, the friction surface or locking member prevents the support member from moving freely along the track and keeps it in its intended position.

In one example, the drive mechanism is an electric drive mechanism including a controller through which the user programs or operates the drive mechanism. The controller may take input from a control pad located on the support device, may be controlled by a remote control, may be controlled by a mobile or web application, etc.

In the embodiment described above, a frame provides structural support for the track. In some embodiments, the track includes one or more track members, each track member including a first end and a second end that are each secured on an internal face of the frame. The frame may be integrated into the support surface or may be added onto a support surface. For example, it may be possible to attach a specialized frame to the backside of a baby bouncer chair to provide the benefits described herein. Alternatively, the frame may be integrated within the seat itself as an OEM feature.

An outer shape of the frame may be square, rectangular, circular, or any other shape depending on the application. For example, a rectangular shape may be appropriate for use under a mattress, while a circular shape may be preferred for localized use on the user's back at the dentist's office, for example. The shape of the frame and the shape of the track can be tailored to each specific use case and take any form that is useful for the given application.

The size and number of the support members may also vary from application to application. For example, it may be useful to use larger support members for varying the pressure points under heavier weights and larger body parts and may be useful to use smaller support members for varying pressure points user lighter weight and smaller body parts.

The thickness of the frame is less than the thickness of the one or more support members. As such, when the variable pressure device is positioned against and secured to an item of furniture (or similar support device), the support members protrude from the surfaces of the frame and press into contact with the support device. Accordingly, when a user rests on the support device, for example a bed, he or she can feel the support members through the mattress.

As described, the variable pressure devices described herein may be integrated into the support device (e.g., furniture) rather than be provided as a retrofit device. For example, the track of the second variable pressure device may be embedded in a mattress, seat, or seat back, such that the movement of the one or more support members occurs within the cushioned member of the device rather than applying pressure through a cushioned member of the device. It is contemplated that an integrated solution may be more successful in larger and more permanent applications that support greater weight and a portable or retrofit solution may be more useful in smaller and more temporary applications.

In another example of this embodiment, a mattress in a child's crib may include a series of independently inflatable air channels or tubes. Each air channel is independently connected to an air compressor through a manifold that includes a valve for each channel. The air compressor sits beneath the crib in which the mattress is used. In a more complex example, the operation of the device may be controlled, for example, by a mobile application, such that the child's caretakers can monitor and operate the device remotely, including the adjustment of the timing and degree of pressure variance. Alternatively, in a less complex example, the operation of the device may be controlled by a simple power button that activates a prescribed inflation and deflation sequence.

For larger applications, such as hospital beds, rather than an air compressor-based system, it may be preferable to use hydraulics with a working fluid that is capable of supporting greater weight. The basic mechanics of the system follow those of the air compressor based system described above.

As described, in one embodiment of the subject matter presented herein, a variable pressure device includes: a user support device including a plurality of inflatable sub-divisions; a pump or compressor; and a manifold assembly including a plurality of valves controlling output of the pump or compressor to selectively inflate and deflate each of the plurality of inflatable sub-divisions. The pump or compressor may be a pneumatic pump or pneumatic compressor or a hydraulic pump or hydraulic compressor, depending on the intended application. The user support device may be any supportive furniture or cushion, such as a mattress, a chair, a pillow, etc. The plurality of inflatable sub-divisions may inflatable channels, air pockets, or other cellular units.

The variable pressure device may further include a controller (i.e., computer processor, memory, and related computing elements) controlling the operation of the pump or compressor and the manifold assembly. The controller may be controlled by a user interface integral with the user support device or may be remotely controlled, for example, by a mobile or web application.

An object of the invention is to provide a device to help to prevent or alleviate discomfort or health concerns related to a user's extended period of time resting on a piece of furniture or similar support device.

An advantage of the invention is that a user is able to vary the pressure points in a support device over time in a controlled (e.g., scheduled) manner.

A further advantage of the invention is that portable embodiments can be positioned against any item of furniture, transforming a traditional support device into one that embodies the advantages provided by the subject matter taught herein.

Yet another advantage of the invention is that it may be fully integrated within a piece of furniture or similar support device.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of an example embodiment of a variable pressure device of the present application.

FIG. 2 is a plan view of the variable pressure device of FIG. 1.

FIG. 3 is a left side elevational view of the variable pressure device of FIG. 1.

FIG. 4 is a cross-sectional view generally taken along lines 4-4 in FIG. 1.

FIG. 5 is a cross-sectional view generally taken along lines 5-5 in FIG. 1.

FIG. 6 is a right side elevational view of the variable pressure device of FIG. 1.

FIG. 7 is a cross-sectional view generally taken along lines 7-7 in FIG. 2.

FIG. 8 is a plan view of an alternative embodiment of a variable pressure device.

FIG. 9 is a side view of the variable pressure device of FIG. 8.

FIG. 10 is a cross-sectional side elevational view of a hospital bed incorporating the variable pressure device of FIG. 8.

FIG. 11 is a plan view of an alternative embodiment of a variable pressure device.

FIG. 12 is a side elevational view of an infant bouncy chair incorporating the variable pressure device of FIG. 11.

FIGS. 13A and 13B are plan views of a further alternative embodiment of a variable pressure device.

FIG. 14 is a cross-sectional view of the variable pressure device of FIG. 13A generally taken along lines 14-14 therein.

FIGS. 15 and 16 illustrate sectional views of the variable pressure device as the support member moves along the track of the variable pressure device.

### DETAILED DESCRIPTION OF THE INVENTION

The present subject matter provides a support device that helps mitigate the adverse consequences resulting from long periods spent sitting or lying in a given position on a support (e.g., chair, mattress, etc.) by altering the manner in which weight is distributed through and supported by the support structure so as to vary the location and magnitude of pressure points experienced by the user over time when supported by the support structure. Various embodiments and examples are provided.

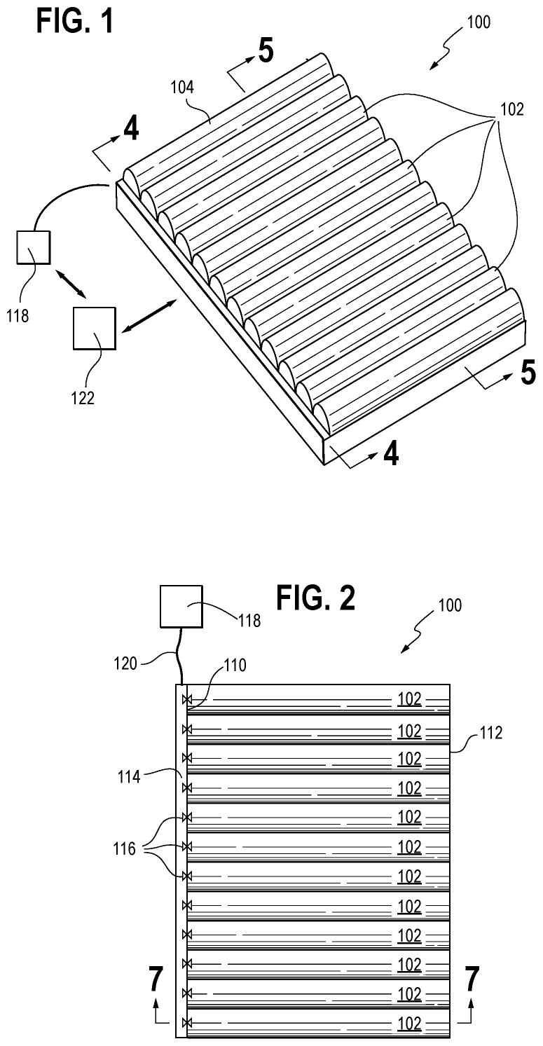

FIGS. 1-7 illustrate an example of a variable pressure device 100 that varies pressure points for a user resting thereon by providing a plurality of inflatable sub-divisions 102 that are selectively inflated and deflated over time. In the illustrated embodiment, the variable pressure device 100 is a mattress body 104 including a series of inflatable subdivisions 102 that are inflated independently of one another.

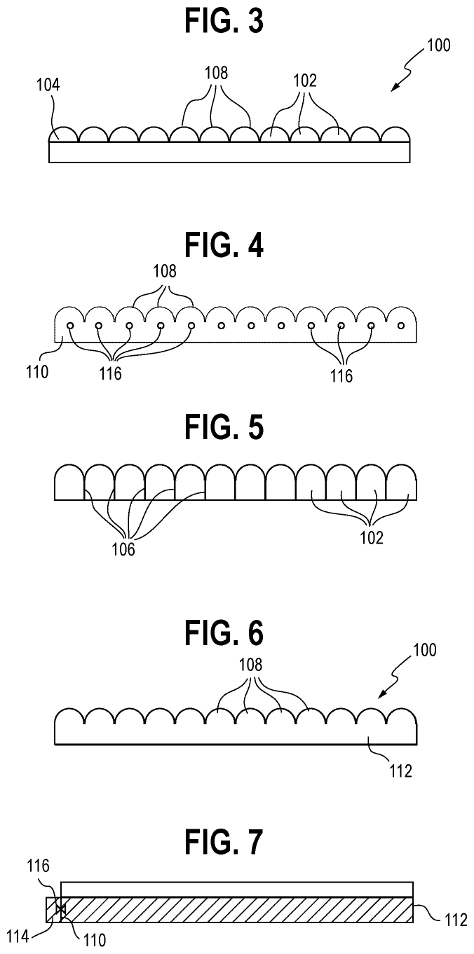

The mattress body 104 of FIGS. 1-7 includes 12 subdivisions extending along a width thereof, although any number of subdivisions may be included as desired. As shown in FIG. 6, eleven dividers 106 are provided within the variable pressure device 100 to separate the body 104 into the subdivisions 102. Each subdivision 102 has a curved upper surface 108 extending between adjacent dividers 106 that forms a semi-circular shape in cross section as shown in FIGS. 3 and 4.

The plurality of subdivisions 102 span opposing first and second end surfaces 110, 112. The first end surface 110 is provided within the mattress body 104 as described in greater detail below. The second end surface 112 forms a right outer side edge of the mattress body 104.

The device 100 also includes a manifold 114 that extends along the first end surface 110 of the plurality of subdivisions 102 and forms a left outer side edge of the mattress body 104. A valve 116 is provided in the first end surface 110 at each subdivision 102 as shown in FIGS. 2 and 7 to regulate airflow into and out of the respective subdivision 102. The manifold 114 fluidly connects the plurality of subdivisions 102 through the valves 116. An air compressor 118 provides air to the manifold 114 through tubing 120 as shown in FIG. 2. For larger applications, such as hospital beds, rather than an air compressor-based system, it may be preferable to use hydraulics with a working fluid that is capable of supporting greater weight.

During use, a user lays along the length of the variable pressure device 100. Using the air compressor 118, the air pressure in each subdivision 102 (or sub-grouping of subdivisions 102) may be increased or decreased over time to vary the location of the pressure applied to different areas of the user's body. In other embodiments, the series of subdivisions 102 may include other shapes and structures, such as square or circular air cells or pockets. It also is contemplated that the variable pressure device 100 of FIGS. 1-7 may be incorporated into any cushioned support device, including seats, conventional beds, hospital beds, conventional mattresses, infant mattresses, pillows, etc.

The variable pressure device 100 may further include a controller 122 (i.e., computer processor, memory, and related computing elements) to control the operation of the air compressor 118 and the valves 116. The controller 122 may be controlled by a user interface integral with the variable pressure device 100 or may be remotely controlled, for example, by a mobile or web application. Such mobile and/or web application may also enable caretakers to monitor as well as operate the device 100, including the adjustment of the timing and degree of pressure variance. Alternatively, the operation of the device 100 may be controlled by a simple power button that activates a prescribed inflation and deflation sequence using the valves 116 and the air compressor 118.

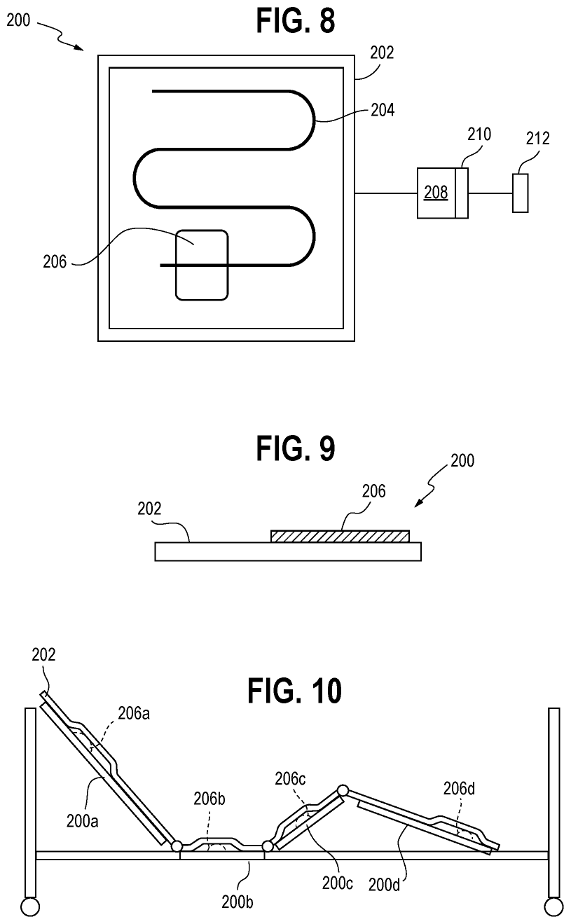

FIGS. 8-16 illustrate further embodiments of variable pressure devices 200, 300, 400 that may be used with various support devices (e.g., furniture or other cushioned support). In the embodiment of FIGS. 8-10, the variable pressure device 200 includes a frame housing 202, a track 204, and one or more support members 206 that move along the length of the track 204. The variable pressure device 200 is secured to the underside of a support structure such as a mattress, a chair, etc., and the support members 206 vary the location of the point(s) of pressure experienced by the user's body when the user is sitting or lying on the support structure. Movement of the support members 206 along the track 204 varies the location of pressure experienced by the user's body.

The track 204 may include a metallic or other suitably rigid member having a linear shape, a serpentine shape, or a series of various shapes, as desired. The support members 206 may be a rounded or curved structure, such as a ball or elongated cylinder. In some examples, the support members 206 rotate about the track 204 as they travel along the length thereof and each may have an irregular or asymmetrical shape such that rotation about the track 204 causes varying pressure on the user.

The travel of the support members 206 along the track 204 may be controlled by a motorized drive mechanism 208. Such drive mechanisms 208 may include controls for varying the speed of travel of the support members 206 along the track 204. It may include a timer such that the support members 206 may travel the track 204 during certain periods of time and not others. For example, the support members 206 may be controlled to move a prescribed distance every five minutes. In another example, the support members 206 may move at a given rate of speed for 15 out of every 60 minutes, while remaining in a stationary position for the remaining 45 minutes. As will be appreciated by those skilled in the art based on the teachings herein, there are essentially limitless variations of movement scheduling that can be implemented.

In one example, the drive mechanism 208 is an electric drive mechanism including a controller 210 through which the user programs or operates the drive mechanism 208. The controller 210 may take input from a control pad 212 located on the support device, may be controlled by a remote control, may be controlled by a mobile or web application, etc.

In the embodiment described above, the frame 202 provides structural support for the track 204. In some embodiments, the track 204 includes one or more track members 204a, each track member 204a including a first end 204a-1 and a second end 204a-2 that are each secured on an internal face 202a of the frame 202. An outer shape of the frame 202 may be square, rectangular, circular, or any other shape depending on the application. For example, a rectangular shape may be appropriate for use under a mattress, while a circular shape may be preferred for localized use on the user's back at the dentist's office, for example. The shape of the frame 202 and the shape of the track 204 can be tailored to each specific use case and take any form that is useful for the given application.

Similarly, the size and number of the support members 206 may vary from application to application. For example, it may be useful to use larger support members 206 for varying the pressure points under heavier weights and larger body parts and may be useful to use smaller support members 206 for varying pressure points user lighter weight and smaller body parts.

In the embodiment shown in FIGS. 8-16, the thickness of the frame 202 is less than the thickness of the one or more support members 206. As such, when the variable pressure device 200 is positioned against and secured to an item of furniture (or similar support device) as shown in FIG. 10, the support members 206 protrude from the surfaces of the frame 202 and press into contact with the support device 102. Accordingly, when a user rests on the support device 102, for example a bed, he or she can feel the support members 108 through the mattress.

Turning to FIG. 10, an example of the variable pressure device 200 used in connection with a hospital bed is shown. As the user reclines in the hospital bed, each of the user's head, upper body, and lower body rests along one of the four surfaces of the hospital bed. A variable pressure device 200 is provided for each of the four surfaces and operate independently. Accordingly, the support members 206 of each variable pressure device 200 may be felt through each of the cushions of the hospital bed.

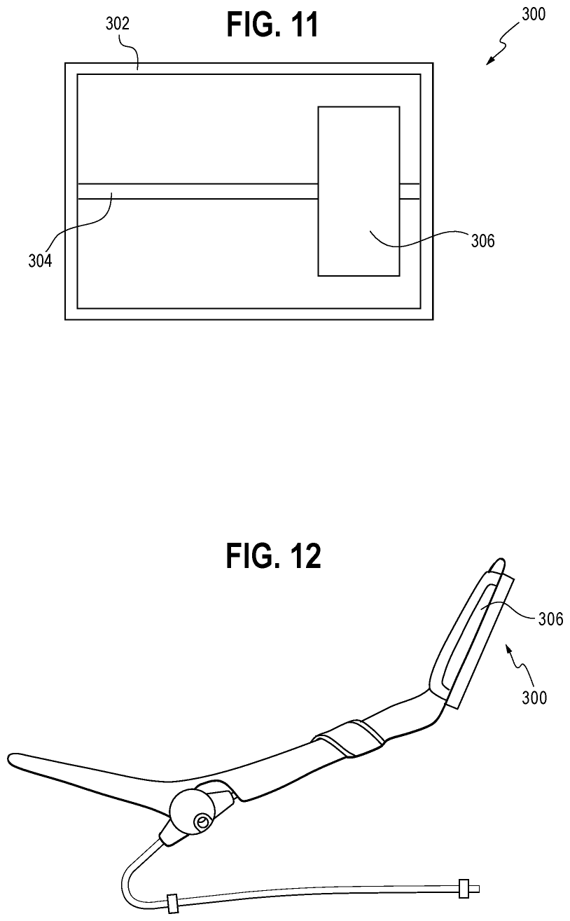

Turning to FIGS. 11 and 12, an example of the variable pressure device 300 used in connection with an infant's bouncy chair is shown. In the example shown in FIG. 11, the variable pressure device 300 is located behind the head rest portion of the chair 118. Accordingly, the support members 308 may be felt through the head rest portion of the chair. When the support members 308 move positions along the back of the head rest portion of the chair, the manner in which the user experiences pressure points from contact with the head rest changes. By altering the positon of the pressure points over time, the user may avoid the negative consequences of prolonged exposure to static pressure points.

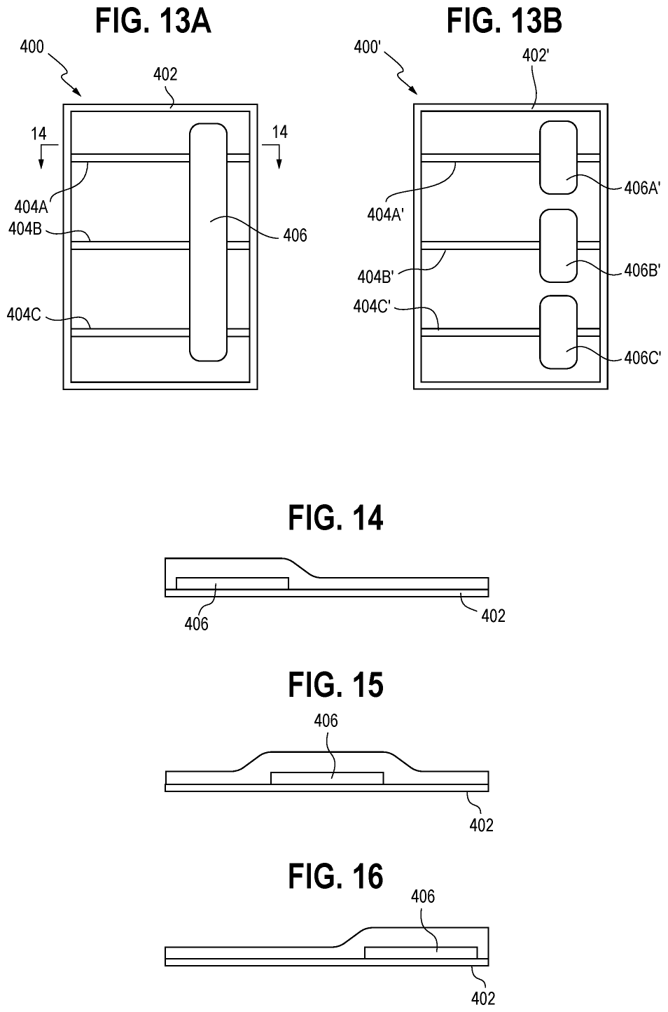

FIGS. 13A, 13B, and 14-16 illustrate a further embodiment of a variable pressure device 400. The variable pressure device 400 includes three track members 404A-C on which a support member 406 moves. In another embodiment illustrated in FIG. 13B, the device 400′ includes three support members 406A-C, each of which moves along a respective track member 404A-C′. Similar to the embodiments described above, the device 400, 400′ may be secured to the underside of a piece of furniture such as a mattress. The device 400 also includes a drive mechanism to control movement of the support member(s) 406, 406A-C′ along the track members 404A-C, 404A-C′.

During use, the drive mechanism causes the support member(s) 406, 406A-C′ to move along the length of the track members 404A-C, 404A-C′ as illustrated in FIGS. 14-16. The position of the support members 406 causes the user's weight to shift in position on the mattress and be supported by the support structure in a way that creates pressure points on the user's body. The movement of the support members 406 along the respective track member 404 causes the user's body to reposition on the support structure, causing the pressure points on the user's body to shift.

Although shown as external, or aftermarket, additions to the support device 102 in FIGS. 2 and 3, the track 106 and support members 108 may be integrated directly into the support device 102 rather than as an external device. For example, the track 106 may be embedded in a mattress, seat, or seat back, such that the movement of the one or more support members 108 occurs within the cushioned member of the support device 102 rather than applying pressure through a cushioned member of the support device 102.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A variable pressure device comprising:
a body including a plurality of inflatable subdivisions;
a pump or compressor; and
a manifold assembly including a plurality of valves controlling output of the pump or compressor to selectively inflate and deflate each of the plurality of inflatable sub-divisions.

2. The variable pressure device of claim 1, wherein the pump or compressor is a pneumatic pump or pneumatic compressor.

3. The variable pressure device of claim 1, wherein the pump is a hydraulic pump or hydraulic compressor.

4. The variable pressure device of claim 1, wherein the user support device is a mattress.

5. The variable pressure device of claim 4, wherein the plurality of inflatable sub-divisions are inflatable channels.

6. The variable pressure device of claim 5, wherein the inflatable channels run in parallel alignment spanning a width of the mattress.

7. The variable pressure device of claim 4, wherein the plurality of inflatable sub-divisions are inflatable air cells.

8. The variable pressure device of claim 1, further comprising a controller controlling the operation of the pump or compressor and the manifold assembly.

9. The variable pressure device of claim 8, wherein the controller is controlled by a user interface integral with the user support device.

10. The variable pressure device of claim 9, wherein the controller is controlled by a user interface remote from the user support device.

11. The variable pressure device of claim 10, wherein the remote user interface includes a mobile application.

12. The variable pressure device of claim 1, wherein the user support device is a chair.

13. The variable pressure device of claim 12, wherein the plurality of inflatable sub-divisions is incorporated into a seat of the chair.

14. The variable pressure device of claim 12, wherein the plurality of inflatable sub-divisions is incorporated into a seat back of the chair.

15. The variable pressure device of claim 12, wherein the plurality of inflatable sub-divisions is incorporated into a headrest of the chair.
